(19) United States
(12) Patent Application Publication
(10) Pub. No.: US 2021/0246777 A1
(43) Pub. Date: Aug. 12, 2021

(54) APPARATUS AND METHOD FOR DOWNHOLE LIGHT WEIGHT CEMENT BOND EVALUATION IN WELLBORE

(71) Applicants: Jinsong Zhao, Houston, TX (US); Jie Li, Houston, TX (US)

(72) Inventors: Jinsong Zhao, Houston, TX (US); Jie Li, Houston, TX (US)

(73) Assignee: GOWell International, LLC, Houston, TX (US)

(21) Appl. No.: 17/240,848

(22) Filed: Apr. 26, 2021

Related U.S. Application Data
(63) Continuation-in-part of application No. 16/011,389, filed on Jun. 18, 2018, now abandoned.

(51) Int. Cl. E21B 47/005; E21B 33/14

(52) U.S. Cl. CPC E21B 47/005; E21B 33/14

(57) ABSTRACT

An apparatus and method to evaluate light-weight cement (LWC) bond conditions behind the casing in a downhole environment of a wellbore. The apparatus includes a logging (CBL) instrument that can detect aberrations in the LWC behind the casing based on variations in the transducer impedance measurements without using pad. The CBL instrument includes a transducer matrix, a signal acquisition controller, a data processing module, and a communication unit.

### CROSS-REFERENCE TO RELATED APPLICATIONS

This application is a continuation-in-part of a U.S. application Ser. No. 16/011,389 filed on Jun. 18, 2018, which is incorporated herein by reference in its entirety.

### FIELD OF INVENTION

The present invention relates to an apparatus and method for inspecting the downhole light-weight cement (LWC) bond conditions behind the casing in a wellbore, and more particularly the present invention relates to an apparatus and method of using acoustic Lamb wave M-bin cyclic forward resonance mode excited by beamformed vortex wave for downhole light-weight cement bond evaluation.

### BACKGROUND

In oil and gas (O&G) wellbores, a cementing operation of casing strings during well completion is utilized to isolate downhole fluid or gas pressure zones for crossflows and leakages, which provides production safety and environment protection. Cement is categorized into three classes normal cement with density around 1750-1850 kg/m³; light-weight cement (LWC) with a density below 1750 kg/m³; and heavy cement with density above 1900 kg/m³. A type of cements chosen for a well completion is based on various reasons, such as field geological characteristics, well structures, and depths, government regulations, etc. LWC gradually becomes favorable in modern well completions because the regulation requires large-depth sections and ranges of well up to entire well depth to be cemented for safety and environment protection. In that case, conventional or heavy weight cement slurries may cause deep formation invasions and clogs, which will largely decrease or cut off formation permeability for oil and gas production after well completion. With LWC, the hydrostatic pressure during cementing is greatly lowered to reduce the escape of cement from the borehole deeply into the formation geological structure to form invasions and clogs.

A wellbore cement bond condition can be deteriorated during the long-time well production lifespan for numerous reasons both geological and operational. It needs to be evaluated periodically downhole. Traditional sonic and ultrasonic logging instruments, logging inside the casing, use acoustic wave reflection mechanism on the bonded interfaces, for example, in between the casing and cement as well as the cement and the formation, to measure the cement bond conditions. The level of wave reflection depends on the material density differences across the interfaces. Since the density of LWC is in a similar range to the density of borehole fluids, it is difficult to reliably evaluate the LWC bond conditions by using the wave reflection method. A few technologies have been developed using Lamb wave in lateral propagation or shear wave in azimuthal propagation for LWC evaluations. Both technologies measure acoustic wavelet signal propagation attenuations corresponding to wave energy losses using a pitch-catch method to estimate LWC bond conditions. Due to the nature of the measurement methods, the instruments need to push the pads with pitch-catch transducers built-in on to the inner surface of the casing as close as possible to get measurability in terms of good enough signal sensitivity, signal-to-noise ratio (SNR), and signal power efficiency. Consequently, it greatly increases tool engineering complexity and operation difficulty, so then, decreases tool reliability. Therefore, there is a demand for a simpler none-pad instrument for LWC bond evaluations with high sensitivity, SNR, and power efficiency.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to an apparatus and method of LWC bond evaluations that is devoid of the aforesaid drawbacks of prior art.

It is another object of the present invention that the apparatus has high sensitivity.

It is a further object of the present invention that the apparatus has high signal-to-noise ratio.

It is still a further object of the present invention that apparatus and associated method is economical in operation.

It is yet another object of the present invention that the apparatus is power efficient.

In one aspect, disclosed is an apparatus and method to evaluate light-weight cement (LWC) bond conditions behind the casing in a downhole environment of a wellbore. The apparatus includes a tool string and a surface unit. The tool string connected to the surface unit through a wireline. The tool string includes a telemetry unit, a centralizer unit, and a cement bond logging (CBL) instrument.

In one aspect, the CBL instrument includes a transducer matrix, a signal acquisition controller, a data processing module, and a communication unit. The transducer matrix can include one or more cylindrical acoustic transducer arrays. Each array can be combined with one or more acoustic azimuthal transducer rings.

In one aspect, the centralizer unit is configured to centralize the tool string within the casing. The centralizer having three or more arms having contact rollers or sliders at their tips that can push against the casing's inner surface to keep the tool string in the center.

In one aspect, disclosed is a method for evaluating the low weight cement bond conditions behind the casing of a wellbore, the method includes the step of power-driving the selected one acoustic transducer array of the transducer matrix with continuous sinusoidal or square wave signals in sequential phase offsets; using the selected frequency of the driving signals that can cause the casing structure into a cyclic forward resonance; generating the acoustic beamformed vortex P-wave in fluid, which excites Lamb A-wave propagating azimuthally inside the casing wall; maintaining a stable structure resonance by applying certain level of input signal energy from the transducer power driver; measuring the input energy level or impedance of the transducer array in the stable resonance mode to estimate energy loss through bond conditions of the LWC behind the casing; and evaluating the LWC bond conditions, such as fully bonded, partially bonded, free pipe condition, by utilizing log measurements and applying the operational workflow including forward modeling, calibration, and inversion.

In one aspect, the downhole instrument of the disclosed apparatus does not need pads with transducers built-in and to be pushed on the inner surface of the casing and does not use pitch-catch or pulse-echo measurement methods to test the attenuation of acoustic wave propagation.

### BRIEF DESCRIPTION OF THE DRAWINGS

FIG. 1 shows a wellbore and the disclosed downhole logging apparatus descended within the casing of the wellbore, according to an exemplary embodiment of the present invention.

FIG. 2 is a top view of the wellbore shown in FIG. 1, according to an exemplary embodiment of the present invention.

FIG. 3 is a block diagram showing an exemplary embodiment of the CBL instrument, according to the present invention.

FIG. 4 is a schematic diagram showing an exemplary embodiment of the transducer matrix, according to the present invention.

FIG. 5 shows an exemplary embodiment of the power-driving signals in a selected frequency. The signals are configured in a format of sequentially divided phase delay offsets and applied to a selected transducer array from the transducer matrix shown in FIG. 4, according to the present invention.

FIG. 6 illustrates a 3-bin rotary vortex waveform as a longitudinal P-wave in the borehole fluid in between the tool string and the casing wall. The vortex waveform is generated and beamformed by the transducer array shown in FIG. 4 with the driving signals shown in FIG. 5. The vortex wavefront propagates outward to the casing wall and eventually reaches the inner surface of the casing, according to an exemplary embodiment of the present invention.

FIG. 7 shows two plate guided Lamb wave propagation modes: Symmetric Mode (S-Wave) and Asymmetric Mode (A-Wave). The displacements of the plate structure nodes from both modes are in a format of elliptical polarized motions that can be projected into shear motion and longitudinal motion referring to the Lamb A-Wave propagation direction.

FIG. 8 shows incident angle β determined by the ratio of P-wave velocity in fluid and Lamb A-Wave velocity inside casing wall. The beamformed wavefront of a vortex P-wave is generated in the way shown in FIG. 6. Under such conditions, casing structure will be in cyclic forward resonance mode where Lamb A-Wave prorogates azimuthally in forward format.

FIG. 9 shows Lamb A-Wave propagating inside casing wall as a plate can be excited across the fluid-to-solid interface by a longitudinal P-wave with a selected incident angle β.

FIG. 10 is a top view of 3-bin Lamb A-wave propagating in azimuthal direction inside the casing wall excited by the vortex wave in fluid shown in FIG. 6 to form a casing cyclic forward resonance by using the critical frequency power-driving signals determined by the methods shown in FIG. 5 and FIG. 9, according to an exemplary embodiment of the present invention.

FIG. 11 shows the case of wellbore structure under the condition of LWC behind casing. In that case, the acoustic energy “loss” from Lamb A-Wave elliptical motion across the interface is projected into two elements inside casing wall: longitudinal motion and shear motion. The acoustic energy carried by both motions can be coupled into the LWC and, thereafter, into the formation. The more energy loss, the less acoustic impedance the structure has.

FIG. 12 shows the case of wellbore structure under the condition of liquid behind casing. In that case, the acoustic energy only from the longitudinal motion can be coupled into the fluid behind the casing. Compared to the case shown in FIG. 11, the acoustic impedance is higher.

FIG. 13 shows the case of wellbore structure under the condition of gas behind casing. In that case, little acoustic energy from both longitudinal motion and shear motion can be coupled into the gas behind the casing. Compared to the cases shown in FIG. 11 and FIG. 12, the acoustic impedance is the highest.

FIG. 14 shows impedance magnitude differences among the three cases shown in FIG. 11, FIG. 12, and FIG. 13. The characteristics of impedance peaks demonstrate the structure resonance behaviors, according to an exemplary embodiment of the present invention. The frequency differences among three cases are due to the differences of structure “rigidness” as the acoustic impedance “load” for the transducers.

FIG. 15 shows the process to operate the instrument for LWC evaluation. It incorporates a forward modeling to roughly determine the resonance frequency for free pipe. Then the instrument will be lowered downhole in the free pipe section to confirm the resonance frequency. Then, the instrument will log the target section of well. A post processing combined with calibration and inversion is conducted to estimate the LWC bond conditions, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

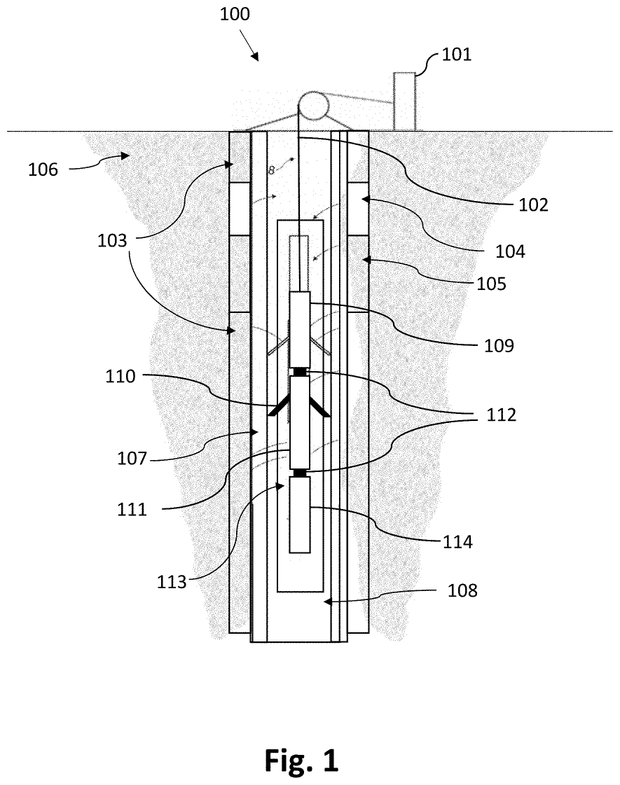

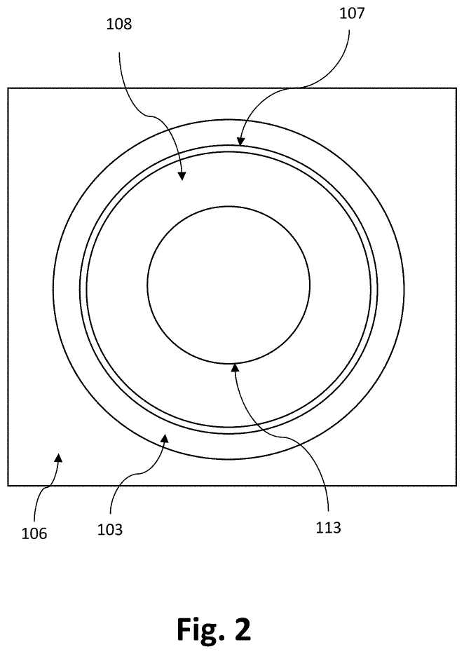

Referring to FIGS. 1 and 2, which shows the disclosed downhole apparatus 100 deployed in a wellbore. Shown is the wellbore having formation 106 and the casing 107. Between the formation 106 and the casing 107 can be seen the light weigh cement (LWC) 103. An interface can exist between the LWC 103 and the casing 107. Presence of gas 104 and/or liquid 105 behind the casing 107 is also shown in FIG. 1. The LWC 103 bonds the casing 107 and the formation 106 together to seal annulus paths for any liquid 105 and or gas 104 leakages from the downhole to the surface. The inner volume of the casing 107 is generally filled with wellbore fluids 108 for acoustic logging purpose.

The disclosed apparatus 100 can include a tool string 113 and a surface unit 101 connected through a wireline 102. The tool string 113 can be supported by the wireline 102 in the downhole environment of the wellbore. The surface unit can include a hoist mechanism for moving the tool string 113 within the wellbore. The wireline 102 can be a cable that can perform at least three functions, first is the transportation for downhole tool string 113 for logging up/down operations. Second, transmitting power from the surface unit 101 to the tool string 113. Third, providing a physical communication link for controlling logging tools and receiving logging data. The surface unit 101 can provide power to the downhole tool string 113, measure well depth, control logging up or down over depth ranges of wellbore sections, and records/displays logging data. The tool string 101 can be suspended within the wellbore and moved through logging up or down. The tool string 113 can be centralized relative to the casing 107 for evaluating the LWC bond conditions across the interfaces of the casing 107 to LWC core 103.

The downhole tool string 113 may include telemetry unit 109, a centralizer unit(s) 111 and a cement bond logging instrument 114. The three units i.e., the telemetry unit 109, the centralizer unit(s) 111, and the cement bond logging (CBL) instrument 114 can be coupled through tool joints 112. As shown in FIG. 1, only one CBL instrument can be used for evaluating the cement bond conditions. The telemetry unit 109 can be a communication hub for forwarding the control commands received from the surface unit 101 through the wireline 102 to the CBL tool 114. The telemetry unit 109 can also provide for transmitting the logging data received from the CBL tool 114 to the surface unit 101. One or more centralizer units 111 can also be included in the tool string 113. Arms 110 of the centralizer units 111 having the contact rollers or sliders on tips can push against the casing's inner surface to keep the tool string 113 in the center of the casing 107 during the logging operations. As a result, the lateral axis of the tool string 113 follows the lateral axis of the casing 107, supported by the centralizer unit 111 during the logging up and down operations.

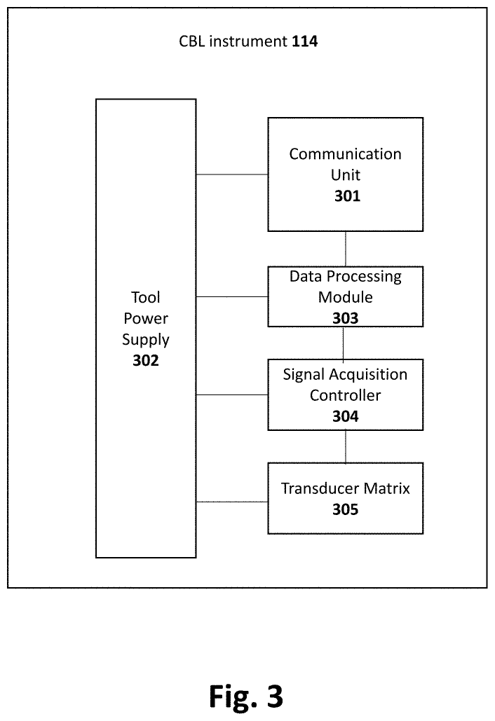

Referring to FIG. 3 which is a block diagram showing components of the CBL instrument 114 that can include a transducer matrix 305, signal acquisition controller 304, data processing module 303, tool power supply 302, and a communication unit 301. The transducer matrix 305 transmits power signals into the wellbore fluid 108 towards the target borehole structure shown in FIG. 1 and receives the responding signals back. The signal acquisition controller 304 sets up the power driving signal 403 to the transducer matrix 305, digitizes the received signals from the transducer matrix 305 into measurement data, and sends the measurement data to the data processing module 303. The data processing module 303 processes the acquired measurement data from the transducer matrix 305 controlled by the signal acquisition controller 304 and outputs the datasets to the communication unit 301 to be sent to the telemetry unit 109. The tool power supply 302 can converts the input electrical power from the wireline cable 102 into multiple purposed power supplies for other elements to use in the proposed CBL instrument 114. The communication unit 301 supports the command and data communication links in between the CBL instrument 114 and the telemetry unit 109 as shown in FIG. 1.

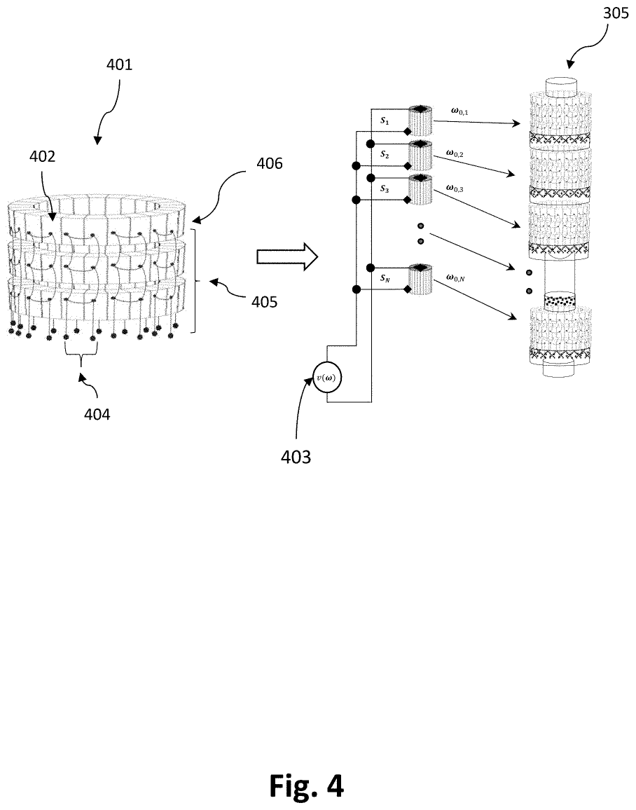

Referring to FIG. 4 which shows an exemplary embodiment of transducer matrix 305. For mechanical assemblies, (1) Several identical acoustic bars 402, which can resonate synchronously in the same natural frequency, with total number of N are physically bonded together laterally with a small spacing in between to form a transducer ring 406; (2) Multiple transducer rings 406 with the same dimension are coaxially assembled as a transducer array 401, and each acoustic transducer array 401 can have its own resonance frequency; (3) Then multiple transducer arrays 401 with the different dimension are coaxially assembled as the transducer matrix 305. For electrical connections, (1) Every two or multiple adjacent bars can be electrically connected into a group as a segment 404 which is isolated electrically from adjacent segments; (2) The segment 404 across multiple transducer rings 406 can be connected electrically in parallel into a transducer array sector 405 in order to increase transducer performances in output signal power level and measurement sensitivity. As illustrated in FIG. 4, the transducer array 401 includes three transducer rings 406, each transducer ring 406 have twenty-four bars 402, twelve segments 404, and twelve transducer array sectors 405.

The transducer matrix 305 can be operated in a range of frequency spectrum in resonance mode covering a wide range of wellbore configurations with different casing sizes (Outer Diameter—OD) and thicknesses (Weight). The transducer array 401 operates in resonance mode during the measurement is chosen for the reason of high efficiency for the transducer array 401 to convert electrical power into vibration power that generates acoustic waves. A power driving circuit 403 can be electrically connected in parallel to the transducer arrays 401 in the transducer matrix 305. The power driving circuit 403 configured to generate power driving signals having a set of sinusoidal waveforms or square waveforms with an equal phase delay offset sequentially. The signals can be connected to the transducer array sectors 405 in the order to form a selective signal array. The signal array electrical connection topology can be one complete cycle or multiple complete cycles driven in parallel so-called M-bin. The combination of transducer array sectors 405 with the power driving signals generates a rotary longitudinal P-wave with one or multiple bin waveforms with the wavefront beamformed to form a vortex waves propagating towards the casing.

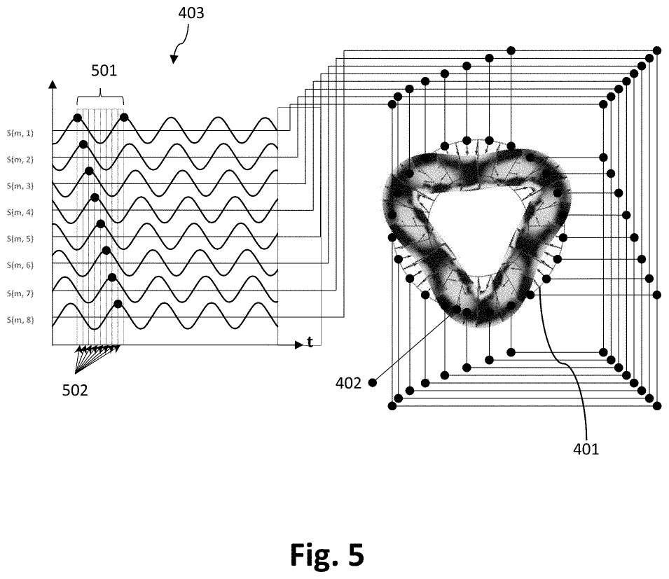

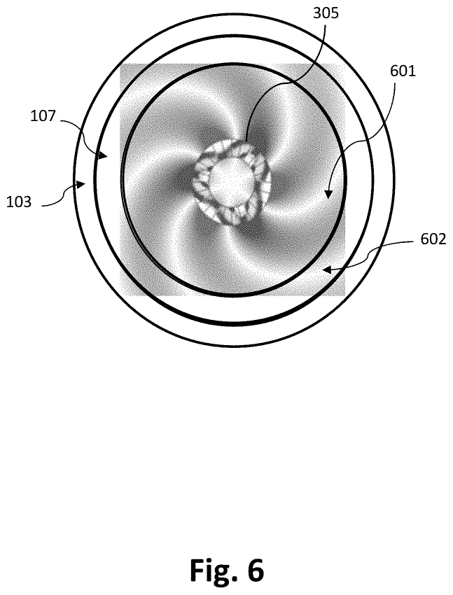

Conceptually, FIG. 5 shows an exemplary embodiment of the power driving signals generated by the power driving circuit 403 with a selected frequency configured in a format of sequentially divided 2π/n phase delay offset sequence 502, applied on the transducer matrix 305 shown in FIG. 4, to generate M-bin vortex acoustic waveforms in the borehole fluid 108 (shown in FIG. 2). The n is the number of phase offsets per signal cycle and M is the number of signal cycles per ring. In the example, the total number of acoustic bars per ring N equals M multiped by n, when each segment 404 only contains one bar 402. During the measurement, the selected transducer array 401 with N bars 501 in its specific resonance frequency to match the wellbore configuration is driven simultaneously with multiple continuous sinusoidal signals or square signals in the same frequency with the 2π/n phase delay offset sequence 502. FIG. 5 shows an example for the case of 3 bins and 4 phase offsets pre signal cycle. As the result, the total number of 24 bars 402 in the transducer ring 406 vibrate and deform sequentially so then to emit a rotary-phase acoustic longitudinal P-wave 601 (shown in FIG. 6) into the surrounding borehole fluid 108.

Referring to FIG. 6, which shows a top view of the rotary-phase longitudinal P-wave 601 propagating in the borehole fluid 108 to form a 3-bin beamformed wavefront vortex waveform in between the transducer matrix 305 and the casing 107. The rotary-phase acoustic longitudinal P-wave 601 can be generated by the transducer matrix 305 shown in FIG. 4 with the power driving signals from driving circuitry 403 shown in FIG. 5. The vortex wavefront propagates outward to the casing 107 wall and, eventually, reaches the inner surface of the casing 107 in an incident angle in favor of an exciting Lamb A-Wave 602 inside the casing 107 wall plate as a Lamb-wave waveguide. The guided Lamb A-Wave 602 will propagate in the azimuthal direction.

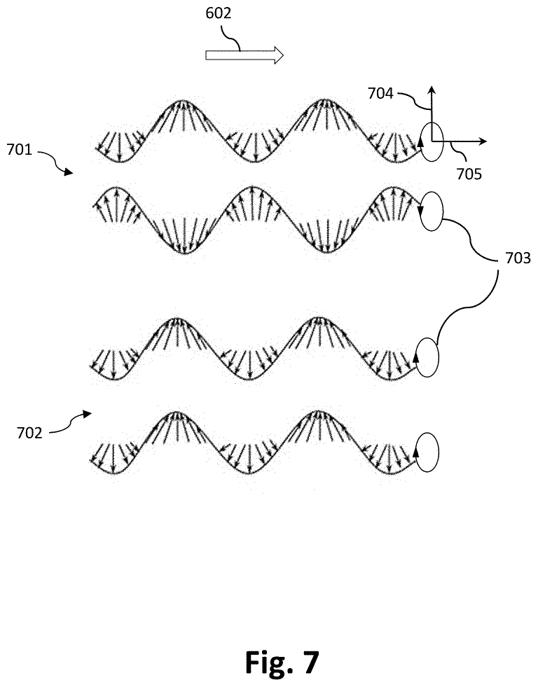

FIG. 7 shows two guided Lamb wave propagation modes: Symmetric Lamb Mode (S-Wave) 701 and Asymmetric Lamb Mode (A-Wave) 702. Both Lamb modes can be excited separately and simultaneously, depending on excitation frequency, incident angle, interface damping, etc. The upper surface and lower surface of the plate bend in the opposite way in S-Wave 701 and in the same way in A-Wave 702. Lamb A-Wave mode 702 is also called flexural mode. The displacements of the plate structure notes in both modes are in the format of an elliptical polarized (rotary) motion 703. The elliptical polarized motion 703 can be projected into a shear motion 704 and longitudinal motion 705 relative to the Lamb wave propagation direction 602. The shear motion 704 is perpendicular to the Lamb wave propagation direction 602 while the longitudinal motion 705 is parallel to the Lamb wave propagation direction 602. In the situation of a casing 107 outer surface bonded with cement 103 in an asymmetric configuration, only Lamb A-Wave 702 can survive. Therefore, in this invention, the driving signal frequency f and incident angle β 801 are chosen only in favor of Lamb A-Wave 702 in a forward resonance mode.

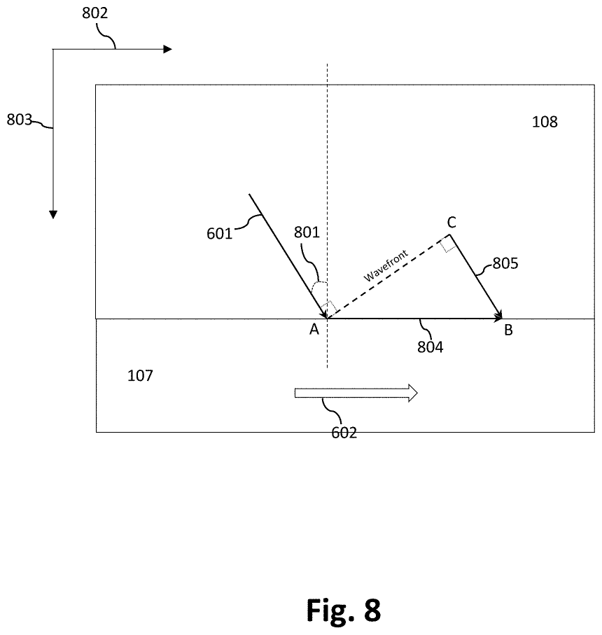

FIG. 8 shows the conditions of a casing structure 107 cyclic forward resonance excited by the vortex wavefront 601 beamformed by the transducer array 401 shown in FIG. 6 with the signals 403 shown in FIG. 5. The condition includes the wavefront incident angle and frequency. The guided Lamb A-Wave 602 and 702 generated inside the casing wall by vortex wavefront 601 propagating in the borehole fluids 108 with the incident angle β 801 and propagates azimuthally along the θ direction shown by arrow 802 in the velocity of v_{L} 804 from the point A to the point B while the vortex wavefront moves from the point C to the point B in the velocity of v_{P} 805 during the same amount of time to build up the same Lamb A-Wave waveform 602 energy level in casing wall 107 due to the phase synchronization condition. Based on the condition, the incident angle β 801 can be calculated.

β=sin^{631 1}(v_{P}/v_{L} (1)

v_{L}=0.92 v_{S} (2)

Where, v_{P} 805 is the acoustic wave velocity of longitudinal P-wave in the fluid 601, v_{L} 804 is the velocity of Lamb A-Wave in the casing 602, and vs is the velocity of shear wave in the casing 107. To generate the casing structure Lamb A-Wave cyclic forward resonance azimuthally in the θ direction 802, the length of the casing 107 circumference must be integer division by wavelength λ of the Lamb A-Wave in the casing. Therefore,

f₀=v_{L}/λ≈(m_{Bin}*v_{L})/(2πR_{CasingOD}) (3)

Where, m_{Bin} is the integer number of wavelengths (λ) along the casing circumference, R_{CasingOD} is the radius of the casing 107 outer diameter (OD).

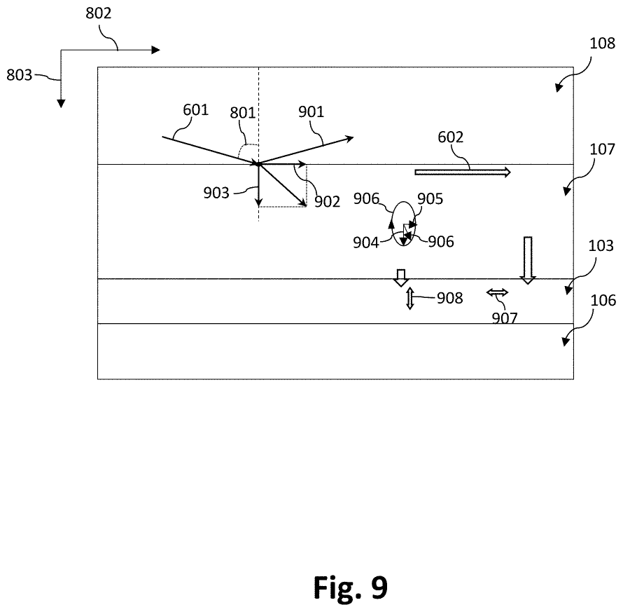

FIG. 9 shows the wave propagation of the guided Lamb A-wave (direction shown by arrow 602) inside the casing wall 107. The vortex wavefront 601, with the incident angle β 801 to the surface of the casing 107, is refracted into the casing 107 and excites the guided Lamb A-Wave 602 propagating azimuthally in θ direction 802. The casing structure node elliptical polarized motion displacement 906 can be decomposed into a shear motion D_{R} 904 and a longitudinal motion D_{θ} 905 referring to the Lamb A-wave propagation direction 602. However, from the casing 107 to cement 103 interface perspective, the longitudinal D_{θ} 905 inside the casing wall 107 is the shear motion D_{S} 907 against the cement surface 103. In principle, when LWC 103 is bonded behind the casing 107, the energy carried by D_{θ} 905 can be coupled proportionally into D_{S} 907 across the bonded 103 interfaces, and the same as when across the interface in between LWC 103 and formation 106. The energy carried by D_{θ} 905 cannot be coupled as a shear motion across the interface when air 104 or fluid 105 is behind the casing 107. The energy carried by D_{R} 904 can be coupled proportionally into D_{P} 908 when either LWC 103 or fluid 104 and 105 is behind the casing.

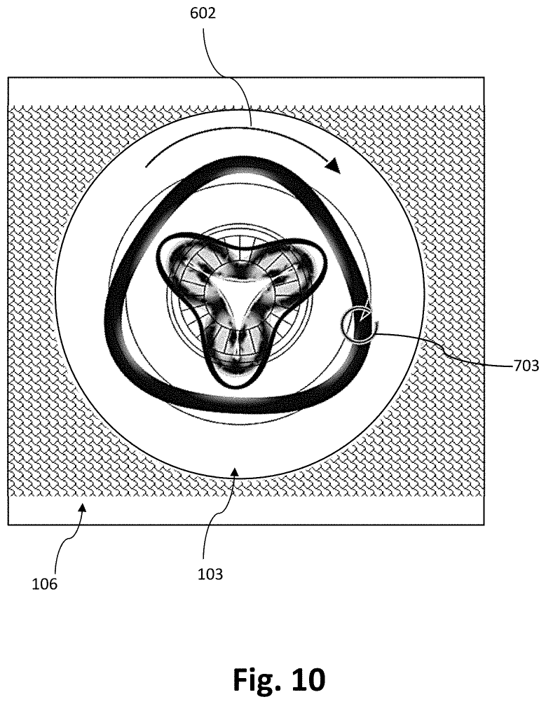

The Lamb A-Wave 602 excited by the vortex wavefront 601 shown in FIG. 6 under the conditions shown in FIG. 8 becomes a casing cyclic forward resonance as shown in FIG. 10. The Lamb A-wave propagation 602 and resonance azimuthally in casing 107 cause the casing structure node elliptical polarized motion 703 on the plane in (R 803, θ 802) of radius direction and azimuthal direction, shown in FIG. 9, where the longitudinal displacement motion D_{θ} 905 inside the casing 107 is projected as a shear motion D_{S} 907 on LWC 103 or fluid 104 and 105 across the interface shown in FIG. 8. Only D_{θ} 905 can be coupled into LWC 103 instead of fluid 104 and 105. Thus, measuring D_{θ} 905 coupling coefficient can be used as the mechanism for LWC evaluation.

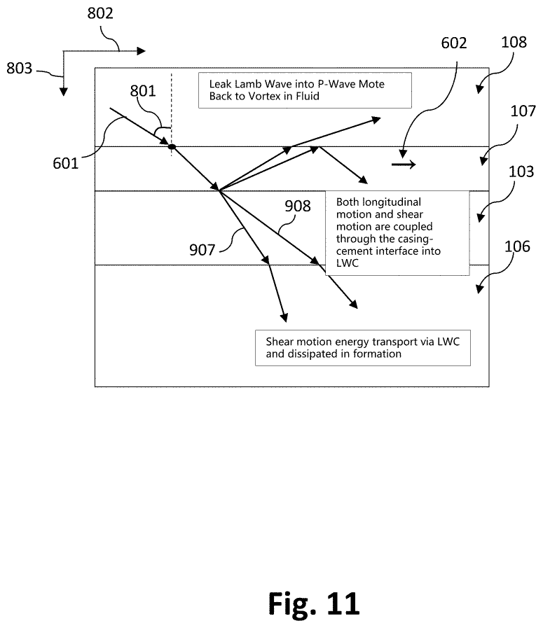

FIG. 11 shows the example where LWC 103 is behind the casing 107 and bonded in between the casing 107 and formation 106. In the LWC layer, both longitudinal D_{P} 908 and shear D_{S} 907 can be excited by the Lamb A-wave 602 from the casing 107-to-LWC 103 interfaces. In that case, the acoustic energy carried by D_{P} 908 and D_{S} 907 transport acoustically through LWC 103 into the formation 106. Consequently, more energy from Vortex P-wave 601 is needed to maintain the stable Lamb A-Wave 602 resonance inside the casing 107 so that more driving power is needed on the transducer array 401 that shows less acoustic impedance as “a power load”.

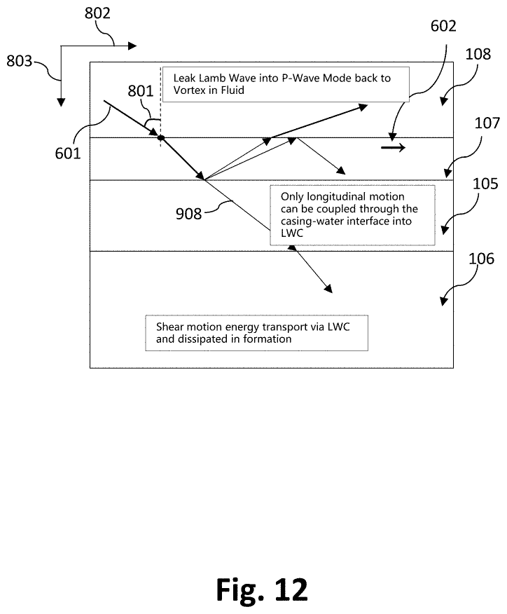

FIG. 12 shows the example where liquid 105 is behind the casing and filled in between the casing and formation. Inside the liquid 105 layer, only longitudinal D_{P} can be excited by the Lamb from the casing-to-liquid interface and generates a longitudinal P-wave propagating towards the formation. In that case, the amount of energy carried by only by the longitudinal D_{P} is less than the one from the case shown in FIG. 11. Consequently, less driving power is needed on the transducer array that shows relatively larger acoustic impedance as “a power load”.

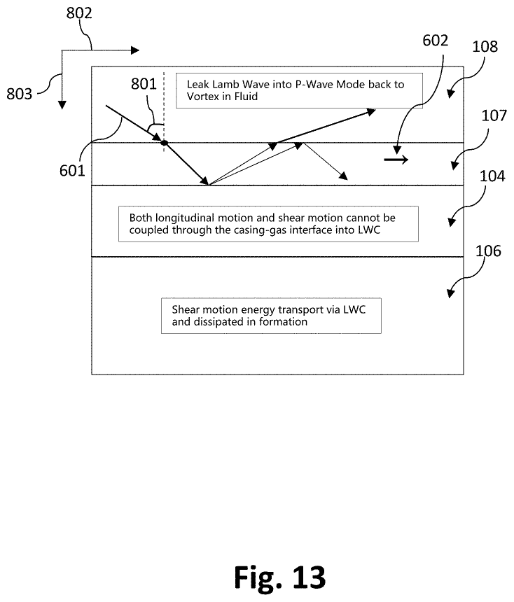

FIG. 13 shows the example where gas 104 is behind the casing 107 and filled in between the casing 107 and formation 106. Inside the gas layer 104, little longitudinal D_{P} 908 and no shear D_{S} 907 can be excited by the Lamb A-wave 602 from the casing 107-to-gas 104 interface and towards the formation 106. In that case, the amount of energy needed to maintain the Lamb A-Wave 602 resonance is the lowest compared to the cases shown in FIG. 11 and FIG. 12. Consequently, less driving power is needed on the transducer array 401 that shows the largest acoustic impedance as “a power load” among all three cases discussed above.

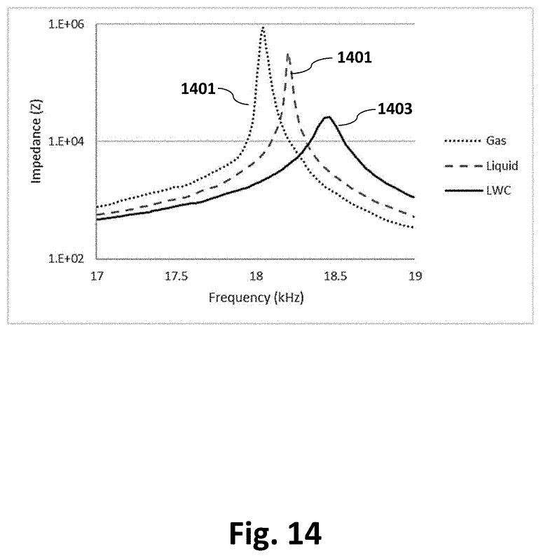

FIG. 14 shows the measured impedance magnitude differences among the cases where either LWC 103 is behind the casing 107 and bonded, or liquid 105 is behind, or gas 104 is behind. The impedance magnitude indicates the driving power needed to maintain a stable level of resonance with a high enough signal to noise ratio. Given a certain level of driving voltage V, measuring the current I can be used to determine the impedance Z according to Ohm's Law.

Z=v/I (4)

And the driving power P (energy) can also be determined in

P=VI=ZI² (5)

Both (4) and (5) show that given selected driving voltage V, Impedance is inverse proportional to the driving power. So, the “solid-line” curve 1403 shows the lowest impedance peak value at the resonance point and more energy is needed in the case of “LWC 103” shown in FIG. 11. The “dash-line” curve 1402 shows the higher impedance peak value that indicated less energy is needed in the case of “liquid 105” shown in FIG. 12. The “dot-line 1401” curve shows the highest impedance peak value that indicated the lowest energy is needed in the case of “gas 104”, shown in FIG. 13, among the three cases.

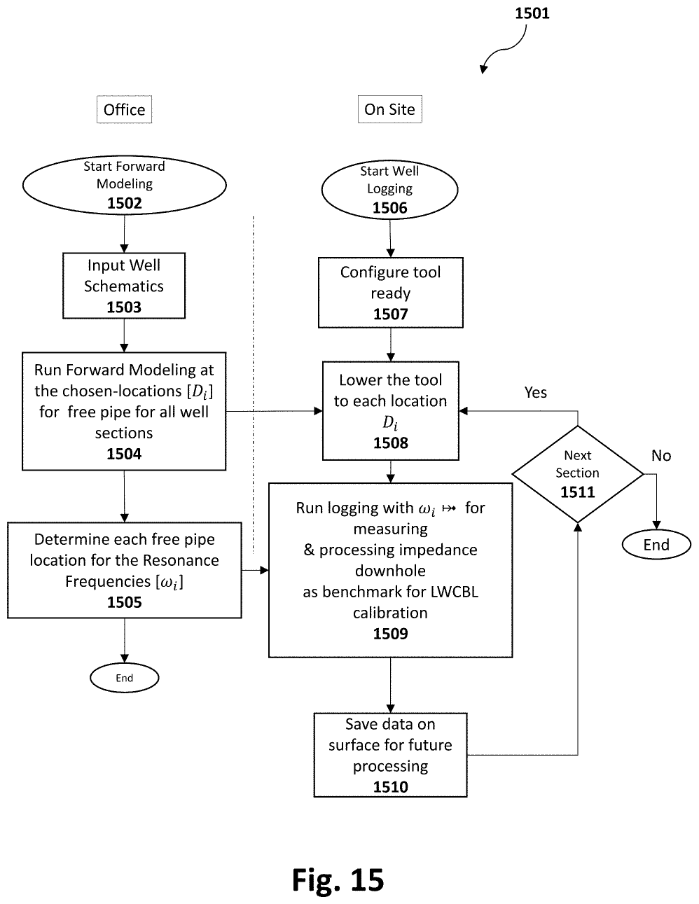

FIG. 15 is the flowchart 1501 of an operational process that can utilize the LWC instrument 114 system including the transducer matrix 305, driving signal, and measurement method to evaluate LWC bond conditions. A forward modeling module 1502 is needed to simulate and predict the resonance frequencies 1505 of the “free” pipe 105 without LWC 103 bonded behind the casing 107 for each of the borehole sections according to the well schematics and configurations 1503. The downhole logging tool string can be inserted into the “free” pipe sections 105 to fine-tune and confirm the resonance frequencies 1504. After that, the tool is operated for logging covering the ranges of the sections for measuring the impedance responses of LWC bond conditions 1506, 1507, and 1508. During or after logging, an inversion algorithm and processing are needed to estimate the LWC bond conditions 1509. For the inversion, a lab tool calibration benchmark dataset may be needed to improve the accuracy of the outcomes 1510.

Furthermore, when the LWC layer 103 behind the casing 107 contains liquid 105 and/or gas 104 in the format 106 of bobbles, gaps, cavities, cracks, fractures, or their combination, as “defects”, the presences of “defects” will cause the wave energy carried by shear motion and longitudinal motion to be partially or entirely reflected towards the casing 107. Thus, less energy is needed to maintain the casing Lamb A-Wave resonance. The impedance peak value varies in between two peaks of LWC 1403 and fluid 1402 or 1401, shown in FIG. 14, indicate that the bond conditions are in the mix of LWC 103 with “defects”. The LWC bond index can be used to describe the bond conditions in percentage numbers. The higher signal is an indication of fluid gaps 104 or 105 being present. The tool can detect the location of gaps within the LWC 103 and the interface of LWC 103 with the casing 107. The gap may be inadequate adhesions between the LWC 103 and the casing 107 or formation 106, cracks in the LWC layer 103, and like gaps known to a skilled person, which are within the scope of the present invention.

Also disclosed is a method of operating the apparatus for measuring and evaluating integrity of LWC bond conditions in between casing and formation in a wellbore. The method includes the steps of forward modeling module, calibration, tuning the casing resonance, logging LWC bond condition, and log data inversion. First, a bond mapping table can be prepared in the lab measuring the CBL instrument outputs matching the known benchmark fixtures with LWC fully and partially bonded behind the casing, fluid behind the casing, gas behind the casing, and predefined the combinations behind the casing. Tuning the casing resonance includes the procedure for inserting and lowering the tool string with the CBL instrument enclosed in and centralized into wellbore to the predetermined depth location where only fluid is behind the casing (free pipe) included in the well depth section range where LWC bond condition will be measured by the instrument. Sweeping the frequency around the predicted frequency from forward modeling calculation needs to be conducted to find the true casing structure resonance frequency and resonance peak, as the reference point calibrated with the lab bonding mapping table, in real time on site. The logging LWC bond condition comprises the LWC logging up and down across the predefined LWC sections for bond condition measurements. The logging data shows the resonance peak level changes along the frequency changes to indicate LWC bond condition changes. The log data shipped to the surface logging unit and saved for further log data inversion process. The log data inversion includes the algorithm for regression based on the mapping table to estimate and evaluate the LWC bond conditions, and then, to plot them along the wellbore depths as the output of the logging apparatus and method.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. An apparatus for measuring and evaluating integrity of a light-weight cement bond conditions in between a casing and formation in a wellbore, the apparatus comprises:
a transducer matrix, the transducer matrix comprises:
one or more cylindrical transducer arrays, each of the one or more cylindrical transducer arrays having a predetermined resonance frequency,
each of the one or more cylindrical transducer arrays comprises a plurality of coaxial transducer rings,
each transducer ring of the plurality of coaxial transducer rings comprised of a plurality of identical acoustic bars that can resonate on its thickness mode synchronously in the same natural frequency generating radial displacements,
each transducer ring of the plurality of coaxial transducer rings divided into a plurality of transducer segments, each transducer segment comprised of two or more of the adjacent identical acoustic bars that are physically bonded together laterally with a small space in between and connected electrically in parallel, and
one or more transducer segments of each transducer ring coupled to one or more transducer segments of the adjacent rings to form a plurality of transducer array sectors; and
a power driving circuit configured for generating power driving signals in sinusoidal waveforms or square waveforms with an equal phase delay offset sequentially, the signals applied in parallel to the plurality of transducer array sectors in one complete cycle or multiple complete cycles.

2. The apparatus according to claim 1, wherein the transducer matrix has at least two cylindrical transducer arrays with different predetermined frequencies.

3. The apparatus according to claim 1, wherein the each of the plurality of transducer array sectors with the power driving signals generate a rotary longitudinal P-wave with one or multiple bin waveforms with the wavefront beamformed to form vortex waves in borehole fluid propagate towards the casing.

4. The apparatus according to claim 3, wherein the number of identical acoustic bars in one transducer ring is multiplication of number of bins and the number of equal signal phase offsets per signal cycle.

5. The apparatus according to claim 3, wherein each of the plurality of transducer array sectors is configured such as the vortex wavefront incidents on an inner surface of a casing wall at an incidence angle such as to excite Lamb A-wave, wherein the guided Lamb A-wave propagates in an azimuthal direction in a casing wall.

6. The apparatus according to claim 5, wherein acoustic wave energy of the guided Lamb A-wave in the casing wall results in a structure node elliptical polarized motion displacement during the casing structure cyclic forward resonance, wherein the cyclic forward resonance is affected by the aberrations in the light-weight cement (LWC) bond conditions behind the casing.

7. The apparatus according to claim 6, wherein the apparatus further comprises an electromechanical impedance measurement for measuring the amount of energy needed to maintain the stable casing structure cyclic forward resonance in Lamb A-Wave mode under the different bond conditions behind the casing, wherein the variation in transducer impedance is related to the bond conditions.

8. The apparatus according to claim 7, wherein the bond conditions include casing-to-LWC, casing-to-liquid, casing-to-gas, wherein the transducer impedance in casing-to-LWC bond condition is different from the transducer impedance in casing-to-liquid or casing-to-gas bond conditions.
